(19) United States
(12) Patent Application Publication
(10) Pub. No.: US 2019/0090505 A1
(43) Pub. Date: Mar. 28, 2019

(54) FROZEN BEVERAGE COMPOSITION CONTAINING HYDROLYZED PEA PROTEIN

(71) Applicant: THE COCA-COLA COMPANY, Atlanta, GA (US)

(72) Inventor: Sandra C. Ryan, Kennesaw, GA (US)

(73) Assignee: THE COCA-COLA COMPANY, Atlanta, GA (US)

(21) Appl. No.: 16/085,103

(22) PCT Filed: Mar. 15, 2017
(86) PCT No.: PCT/US2017/022511

§ 371 Date: Sep. 14, 2018

Related U.S. Application Data
(60) Provisional application No. 62/308,445, filed on Mar. 15, 2016.

(51) Int. Cl. A23G 9/38; A23G 9/04; A23L 2/54; A23L 2/66; A23L 2/38

(52) U.S. Cl. CPC A23G 9/38; A23G 9/045; A23V 2002/00; A23L 2/66; A23L 2/38; A23L 2/54

(57) ABSTRACT

A frozen beverage composition containing hydrolyzed pea protein, and methods of making the same. The addition of hydrolyzed pea protein to non-carbonated frozen beverages has been found to produce aeration, density, and mouth feel similar to that of a carbonated frozen beverage.

### CROSS REFERENCE TO RELATED APPLICATIONS

This application claims the benefit of priority to U.S. Provisional Application No. 62/308,445, filed Mar. 15, 2016, which is incorporated herein by reference in its entirety.

### TECHNICAL FIELD

The present disclosure relates to frozen beverage compositions and methods of making the same.

### BACKGROUND OF THE INVENTION

In various applications, frozen beverages are typically produced with a beverage base, a diluent, and ice. For example, frozen beverages can be produced by blending a beverage concentrate, carbonated or non-carbonated water, and ice. Thus, frozen beverages can be carbonated or non-carbonated and generally, carbonated frozen beverages have more aeration or overrun than non-carbonated frozen beverages. Accordingly, carbonated frozen beverages typically exhibit lighter density and mouth feel than non-carbonated frozen beverages.

The aeration or overrun, lighter density, and lighter mouth feel of carbonated frozen beverages are characteristics which may be more appealing to consumers. However, carbonated frozen beverages require additional storage for carbonation equipment, and may create mechanical problems in the machinery used to produce the frozen beverage. For example, carbonated frozen beverages may be difficult to freeze or maintain at the appropriate consistency, and chilled carbonated water or beverage may cause unacceptably high pressures to accumulate within the machinery.

Therefore, it would be desirable to provide a frozen beverage which requires little or no carbonation and yet provides a consumer with a frozen beverage which has a lighter density and mouth feel similar to that of a carbonated beverage. More particularly, it would be desirable to provide a frozen beverage composition and method of making the same, requiring little or no carbonation to provide an aerated, lighter density, lighter mouth feel frozen beverage as compared to traditional non-carbonated frozen beverages.

### SUMMARY OF THE INVENTION

In one aspect, the present disclosure relates to frozen beverage components, frozen beverage compositions, and methods of making a frozen beverage. The frozen beverage compositions and methods described herein provides the consumer with a frozen beverage having a lighter density that conventional frozen beverages and a mouth feel similar to that of a carbonated frozen beverage. Moreover, these desirable features are provided by using little or no carbonation.

In an aspect for example, the disclosure relates to a frozen beverage component comprising hydrolyzed pea protein and at least one beverage constituent. In another aspect, this disclosure relates to a frozen beverage composition comprising hydrolyzed pea protein, at least one beverage constituent, and at least one diluent. In another aspect, the present disclosure relates to methods of making a frozen beverage composition comprising blending a hydrolyzed pea protein and at least one beverage constituent with at least one diluent and ice in conventional equipment for making a frozen beverage composition.

Surprisingly, it has been discovered that the use of hydrolyzed pea protein in frozen beverages produces non-carbonated frozen beverages with more aeration, lighter densities and mouth feel than non-carbonated frozen beverages without hydrolyzed pea protein. In fact, hydrolyzed pea protein in frozen beverages has been found to produce non-carbonated frozen beverages with aeration, density, and mouth feel similar to traditional carbonated frozen beverages. Accordingly, in one aspect, the present disclosure allows for frozen beverages to be produced with aeration, density and mouth feel similar to that of a traditional carbonated frozen beverage without the need for carbonation.

These and other aspects, features, and embodiments of the present disclosure will be understood by reference to detailed disclosure and the claims provided herein.

### DETAILED DESCRIPTION OF THE INVENTION

Provided in this disclosure are new frozen beverage components, frozen beverage compositions, and methods of making frozen beverages. In an aspect, for example, there is provided a frozen beverage component comprising hydrolyzed pea protein, at least one beverage constituent, and if desired, at least one diluent. Various methods of making frozen beverages are provided utilizing standard equipment, such that no new, unconventional, or non-versatile equipment is required to make the frozen beverages.

To define more clearly the terms used herein, the following definitions are provided to further explain and elaborate various aspects of this disclosure, which are applicable unless otherwise indicated by the disclosure itself or by the context. To the extent that any definition or usage provided by any document incorporated by reference herein conflicts with the definition or usage provided in this disclosure, the definition or usage provided herein controls.

Throughout the specification and claims, the word “comprising” and variations of the word, such as “comprise” and “comprises,” means “including but not limited to,” and is not intended to exclude, for example, other additives, components, elements, or steps. While compositions and methods are described in terms of “comprising” various components or steps, the compositions and methods can also “consist essentially of” or “consist of” the various components or steps. That is, the compositions and methods described herein can comprise, consist of, and consist essentially of the essential elements and limitations of the invention described herein.

“Beverage,” as used herein includes, but is not limited to, a pulp or pulp-free citrus or non-citrus fruit juice, fruit drink, fruit-containing beverage, fruit-flavored beverage, citrus-flavored beverage, vegetable juice, vegetable drink, vegetable containing beverage, milk, soy milk, soy-enhanced drink, protein drink, tea, coffee, dairy beverage, sports drink, energy drink, flavored water, isotonic drink, vitamin-enhanced water, soft drink, smoothie, yogurt drink, hot chocolate, a non-carbonated beverage, a carbonated beverage, and the like, including and combinations thereof. Therefore, the beverage may be carbonated or non-carbonated.

“Frozen beverage,” as used herein, includes, but is not limited to, a beverage which is at least partially frozen, or a beverage which is blended with ice.

“Beverage constituent” as used in this disclosure refers to portions of the beverage, an additive, or a beverage itself which do not comprise the specific claimed diluent or the hydrolyzed pea protein. That is, the beverage constituent can include any one or any combination of more than one of a beverage base, flavor, flavor concentrate, preservatives such as sodium benzoate, potassium benzoate, potassium sorbate, sodium hexametaphoshpate and the like, oil, flavor oil, colorant, sweetener, natural sweetener, artificial sweetener, branded beverage base or syrup, juice, juice product, pulp, food acids, pH adjusters, antioxidants, thickeners, nutritional additives, non-nutritional additives, micro-ingredients, macro-ingredients, a blended beverage, extracts, syrup, concentrates of any type including concentrates of any above-recited constituent, and the like, including any combinations of these constituents. That is “beverage constituent” includes any number or combination of beverage components, whether in concentrated or non-concentrated form, and can also include a diluent such as water. Essentially, the beverage component largely dictates the identity of the beverage being produced.

“Diluent” as used in this disclosure refers to portions of the frozen beverage which increase the volume of the frozen beverage, thereby reducing the concentration of at least one beverage constituent. Diluents may include but are not limited to ice, water, carbonated water, and beverages.

According to certain aspects and embodiments, beverage constituents may comprise parts of beverages which may be considered food items by themselves, such as soy, protein, or dairy products. In some aspects, beverage constituent or constituents may comprise a beverage itself.

Reference throughout this specification to “one embodiment,” “an embodiment,” or “embodiments” means that a particular feature, structure, or characteristic described in connection with the embodiment is included in at least one embodiment. Thus, the appearances of the phrases “in one embodiment” or “in an embodiment” in various places in the specification are not necessarily all referring to the same embodiment. Furthermore, the particular features, aspects, structures, or characteristics may be combined in any suitable manner in one or more embodiments.

“Optional” or “optionally” means that the subsequently described element, component, step, or circumstance can or cannot occur, and that the description includes instances where the element, component, step, or circumstance occurs and instances where it does not.

In an aspect and according to certain embodiments, the beverage constituent may include or further comprise vitamins, dairy products, soy products, food products, beauty products, health care products and combinations thereof. Additionally, beverage constituents according to some embodiments or aspects of this disclosure may be in forms including, but not limited to, liquids, gases, gels, colloids, solid/fluid mixtures or suspensions, liquid/gas mixtures or solutions, and mixtures thereof. In some embodiments, the beverage constituent may comprise flavor oils, emulsifiers, colors, and other additives.

According to certain aspects of the disclosure, the beverage constituent may comprise ingredients for providing a frozen beverage such as a citrus beverage that contains citrus flavor, flavor oil, and/or juice, along with the hydrolyzed pea protein. For example, this disclosure provides for frozen orange flavor beverage, a frozen lemon flavor beverage, a frozen lime flavor beverage, a frozen lemon-lime flavor beverage, a frozen orangeade beverage, a frozen lemonade beverage, a frozen limeade beverage, a frozen lemonade-limeade beverage, a frozen cherry beverage, a frozen grape beverage, a frozen strawberry beverage, a frozen pineapple beverage, a frozen mango beverage, and the like, having hydrolyzed pea protein. This listing is non-limiting, and is intended to be representative of the beverage constituent components that can be used according to this disclosure.

Also according to some aspects or embodiments of the present disclosure, the beverage constituent may comprise ingredients for producing a branded beverage including, but not limited to, SPRITE®, FANTA®, MINUTEMAID®, Hi-C®, POWERADE®, FUZE® or VITAMIN WATER®. This listing is also non-limiting, and is intended to be representative of the beverage constituent components that can be used according to this disclosure.

In certain aspects or embodiments of the present disclosure, a frozen beverage may be produced by blending hydrolyzed pea protein, at least one beverage constituent, and ice in a “blended ice machine” which will be known by those of skill in the art. For example, one such blended ice machine is the MULTIPLEX® MS-8-1-H. In some aspects a further diluent besides ice may also be blended in the machine. For example, in some aspects, a frozen beverage may be produced by blending hydrolyzed pea protein, at least one beverage constituent, ice, and a further diluent in a blended ice machine. In other aspects, a frozen beverage may be produced by blending hydrolyzed pea protein, at least one beverage constituent, and ice in a “blend-in-cup” (“BIC”) machine, which also will be known by those of skill in the art. In some aspects, a further diluent besides ice may also be blended in the machine. For example, in some aspects, a frozen beverage may be produced by blending hydrolyzed pea protein, at least one beverage constituent, ice, and a further diluent in a BIC machine.

Frozen beverages according to aspects or embodiments may be produced by blending hydrolyzed pea protein, at least one beverage constituent, and ice in any frozen beverage system or equipment known to one of skill in the art, such as those described in U.S. Patent Pub. No. 2011/073212; U.S. Patent Publ. No. 2011/0023505; U.S. Patent Publ. No. 2015/0069087; U.S. Patent Publ. No. US 2016/0016133; U.S. Pat. No. 8,505,595; U.S. Patent Publ. No. 2016/0007801; and U.S. Pat. No. 8,690,016. In some aspects, a further diluent besides ice may also be blended in the equipment.

in other aspects, frozen beverages may be produced by blending a mixture of ingredients comprising hydrolyzed pea protein, at least one beverage constituent, and at least one diluent and freezing the mixture of ingredients in a “frozen beverage dispenser,” sometimes also referred to as a “granita dispenser.” As would be readily understood by those skilled in the art, frozen beverage dispensers freeze a mixture of ingredients including at least one beverage constituent, a diluent such as water, and optionally, carbon dioxide or other gases in a mixing chamber. In some aspects, the mixture of ingredients may be produced ahead of time and simply supplied to the mixing chamber of the machine as a single component. In others, one or more of the ingredients may be mixed together in the mixing chamber of the machine, so that two or more of the ingredients are provided to the machine as separate components. As would be readily understood by those of skill in the art, in a frozen beverage dispenser, the mixture of ingredients freezes on the inner surface of the mixing chamber, which is surrounded by an evaporator through which a refrigerant is passed. A mixer, is disposed inside the mixing chamber. For example, the mixer may be a rotating shaft which has a plurality of outwardly projecting or helical blades/auger which scrape the mixture off the inside walls of the mixing chamber. Once the beverage is in the desired frozen state, the product is dispensed from the mixing chamber through a product dispensing valve.

In one aspect, a frozen un-carbonated beverage (FUB) may be produced in a frozen beverage dispenser from a mixture of ingredients including the hydrolyzed pea protein disclosed herein, wherein the FUB has a mouth feel similar to a frozen carbonated beverage (FCB). In another aspect, a frozen un-carbonated beverage (FUB) may be produced in a frozen beverage dispenser from a mixture of ingredients including the hydrolyzed pea protein disclosed herein, wherein the FUB has an expansion higher than a FUB without the hydrolyzed pea protein, or similar to a frozen carbonated beverage (FCB). In some aspects, a FCB may be produced in a frozen beverage dispenser from a mixture of ingredients including the hydrolyzed pea protein disclosed herein, wherein the FCB has an enhanced mouth feel compared to the mouth feel of a FCB without the hydrolyzed pea protein disclosed herein. As used herein, “enhanced mouth feel” includes an enhanced light and fluffy mouth feel experience.

The frozen beverages according to this disclosure are not limited as to the specific weight percentage or amounts of hydrolyzed pea protein that can be used in blending. For example and not as a limitation, the weight percentage of pea protein (for example, Hyfoama PW) in the finished beverage that provides the desirable properties can be from about 0.01 wt % to about 3 wt %. The weight percentage of pea protein in the finished beverage can also be from about 0.05 wt % to about 1 wt %, or alternatively, from about 0.1 wt % to about 0.3 wt %. In another aspect, the weight percentage of pea protein in the finished beverage can be (in weight percentage) about 0.01 wt %, 0.02 wt %, 0.03 wt %, 0.04 wt %, 0.05 wt %, 0.06 wt %, 0.07 wt %, 0.08 wt %, 0.09 wt %, 0.10 wt %, 0.11 wt %, 0.12 wt %, 0.13 wt %, 0.14 wt %, 0.15 wt %, 0.16 wt %, 0.17 wt %, 0.18 wt %, 0.19 wt %, 0.20 wt %, 0.21 wt %, 0.22 wt %, 0.23 wt %, 0.24 wt %, 0.25 wt %, 0.26 wt %, 0.27 wt %, 0.28 wt %, 0.29 wt %, 0.30 wt %, 0.31 wt %, 0.32 wt %, 0.33 wt %, 0.34 wt %, 0.35 wt %, 0.36 wt %, 0.37 wt %, 0.38 wt %, 0.39 wt %, 0.40 wt %, 0.45 wt %, 0.50 wt %, 0.55 wt %, 0.60 wt %, 0.65 wt %, 0.70 wt %, 0.75 wt %, 0.80 wt %, 0.85 wt %, 0.90 wt %, 0.95 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.5 wt %, 3.0 wt %, 3.5 wt %, 4.0 wt %, 4.5 wt %, or 5.0 wt %. Moreover, any range between any of these disclosed values are also disclosed herein.

The amount of pea protein used in the disclosed frozen beverage can be lower than would ordinarily employed in a food product for nutritional purposes. For example, the amount of pea protein used in the disclosed frozen beverage may be less than about 5 grams per 8 fl. oz. serving of the frozen beverage, less than about 4 grams per 8 fl. oz. serving of the frozen beverage, or less than about 1 gram per 8 fl. oz. serving of frozen beverage. In some embodiments, the amount of pea protein present in the disclosed frozen beverage may be in an amount of about 0.1 to 0.6 grams of pea protein per 8 fl. oz. of frozen beverage. That is, the effects and properties that pea protein surprisingly impart to a frozen beverage, such as aeration, expansion, density, and mouth feel characteristics, were also surprisingly discovered to occur at comparatively low concentrations. Further, the sensation of carbonation—even in a non-carbonated frozen beverage—was unexpected in the disclosed compositions and enhanced the light and fluffy drink experience.

Similarly, the frozen beverage component or syrup that is used to prepare the frozen beverage according to this disclosure can comprise a range of pea protein and be suitable for preparing a frozen beverage as described herein. For example, the weight percentage of hydrolyzed pea protein in the frozen beverage component or syrup can be about 0.1 wt % to about 5 wt %, or alternatively from about 0.3 wt % to about 3 wt %. Alternatively, the weight percentage of hydrolyzed pea protein in the frozen beverage component or syrup can be about 0.5 wt % to about 1 wt %. In another aspect, the weight percentage of pea protein in the frozen beverage component or syrup can be about 0.1 wt %, 0.2 wt %, 0.3 wt %, 0.4 wt %, 0.5 wt %, 0.6 wt %, 0.7 wt %, 0.8 wt %, 0.9 wt %, 1 wt %, 1.5 wt %, 2.0 wt %, 2.5 wt %, 3.0 wt %, 3.5 wt %, 4.0 wt %, 4.5 wt %, or 5.0 wt %. Moreover, any range between any of these disclosed values are also disclosed herein.

The frozen beverages according to this disclosure are not limited as to the specific weight percentage or amounts of water (including ice) that can be used in blending. For example and not as a limitation, the weight percentage of water (including ice) in the finished beverage that provides the desirable properties can be from about 80 wt % to about 97 wt %. The weight percentage of water in the finished beverage can also be from about 82 wt % to about 94 wt %, or alternatively, from about 85 wt % to about 90 wt %. In another aspect, the weight percentage of water in the finished beverage can be (in weight percentage) about 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, or 97 wt %. Moreover, any range between any of these disclosed values are also disclosed herein.

Similarly, the frozen beverage component or syrup that is used to prepare the frozen beverage according to this disclosure can comprise a range of water including ice and be suitable for preparing a frozen beverage as described herein. For example, the weight percentage of water in the frozen beverage component or syrup can be about 45 wt % to about 65 wt %, or alternatively from about 50 wt % to about 63 wt %. Alternatively, the weight percentage of water in the frozen beverage component or syrup can be about 55 wt % to about 60 wt %. In another aspect, the weight percentage of water in the frozen beverage component or syrup can be about 45 wt %, 46 wt %, 47 wt %, 48 wt %, 49 wt %, 50 wt %, 51 wt %, 52 wt %, 53 wt %, 54 wt %, 5 wt %, 56 wt %, 57 wt %, 58 wt %, 59 wt %, 60 wt %, 61 wt %, 62 wt %, 63 wt %, 64 wt %, or 65 wt %. Moreover, any range between any of these disclosed values are also disclosed herein.

The frozen beverages according to this disclosure are not limited as to the specific weight percentage or amounts of the beverage constituent and additional components (including sweetener) that can be used in blending. For example and not as a limitation, the weight percentage of the beverage constituent and additional components, combined, in the finished beverage that provides the desirable properties can be from about 3 wt % to about 20 wt %. The weight percentage of the beverage constituent and additional components in the finished beverage can also be from about 6 wt % to about 18 wt %, or alternatively, from about 10 wt % to about 15 wt %. In another aspect, the weight percentage of the beverage constituent and additional components in the finished beverage can be (in weight percentage) about 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %. Moreover, any range between any of these disclosed values are also disclosed herein.

Similarly, the frozen beverage component or syrup that is used to prepare the frozen beverage according to this disclosure can comprise a range of beverage constituent and additional components (including sweetener) and be suitable for preparing a frozen beverage as described herein. For example, the weight percentage of beverage constituent and additional components in the frozen beverage component or syrup can be about 35 wt % to about 55 wt %, or alternatively from about 37 wt % to about 50 wt %. Alternatively, the weight percentage of flavor system and additional components in the frozen beverage component or syrup can be about 40 wt % to about 45 wt %. In another aspect, the weight percentage of the beverage constituent and additional components (including sweetener) in the frozen beverage component or syrup can be about 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, or 55 wt %. Moreover, any range between any of these disclosed values are also disclosed herein.

Depending on the particular beverage being prepared, any number of additional beverage components can be added or included in the frozen beverage, in addition to those previously described. For example, at least one acid or food acid can be added. The acid or food acid can comprise or be selected from phosphoric acid, lactic acid, citric acid, fumaric acid, tartaric acid, malic acid, ascorbic acid or any combination thereof.

In another aspect, additional component that can be added or included in the frozen beverage, in addition to those previously described, can comprise or be selected from flavor oils, flavor chemicals, natural flavor extracts, caramel, preservatives, caffeine, caloric sweeteners, non-caloric sweeteners, or any combinations thereof.

In a further embodiment, an addition of one or more squirts or “shots” from a beverage bar gun or a similar device of a carbonated beverage including carbonated water, non-flavored carbonated beverage, or a flavored carbonated beverage described herein can be added to after the preparation of a non-carbonated frozen beverage. In another embodiment, the additional squirts or “shots” of a carbonated beverage including carbonated water, non-flavored carbonated beverage, or a flavored carbonated beverage described herein can be added manually after the preparation of a non-carbonated frozen beverage.

Frozen uncarbonated beverages can be prepared according to aspects of the disclosure which have about 5% expansion, about 10% expansion, about 15% expansion, about 20% expansion, about 25% expansion, about 30% expansion, about 35% expansion, about 40% expansion, as z % expansion is defined herein, and any ranges therebetween.

Frozen carbonated beverages can be prepared according to aspects of the disclosure which have about 70% expansion, about 75% expansion, about 80% expansion, about 85% expansion, about 90% expansion, about 95% expansion, about 100% expansion, about 105% expansion, about 110% expansion, about 115% expansion, about 120% expansion, as % expansion is defined herein, and any ranges therebetween.

FUBs may be prepared according to aspects of the disclosure which have an expansion significantly higher than a comparable FUB without the hydrolyzed pea protein. As used herein, “comparable FUB without the hydrolyzed pea protein” means a FUB containing the same beverage constituent(s) and diluent(s) in the same amounts without any hydrolyzed pea protein. For example, in some aspects, FUBs may be prepared according to aspects of the disclosure which have an expansion of from 100% to 400% of the expansion of a comparable FUB without the hydrolyzed pea protein, including any and all ranges therebetween.

### EXAMPLES

Beverages were made using the Hyfoama PW whipping agent, which is based on hydrolyzed pea protein and obtained from Kerry Ingredients & Flavours Ltd. The Hyfoama PW product includes 80-90 wt % hydrolyzed pea protein and 10-20 wt % sugar.

### Example 1

A FANTA® frozen beverage was made in a blended ice machine, in accordance with the present disclosure. First, a frozen beverage component (“syrup”) was prepared which comprised 56.5 weight percent water, 41.5 weight percent sucrose, 0.73 weight percent hydrolyzed pea protein (Hyfoama PW from Kerry Ingredients & Flavours Ltd.), 0.66 weight percent citric acid, and 0.61 weight percent of a proprietary FANTA® orange beverage constituent.

This frozen beverage component was blended with ice in a blended ice machine at a blend of 32.2 weight percent syrup with 67.8 weight percent ice to produce a frozen beverage composition comprising 87.5 weight percent water (in both solid and liquid form), 11.8 weight percent sucrose, 0.21 weight percent pea protein, 0.19 weight percent citric acid, and 0.17 weight percent of a FANTA® orange beverage constituent.

Surprisingly, the addition of the hydrolyzed pea protein produced a non-carbonated frozen beverage composition having the aeration, density, expansion, and mouth feel characteristics of a traditional carbonated frozen beverage.

### Example 2

A frozen beverage component (syrup) can be prepared which contains from about 40 wt % to about 65 wt % water (diluent), from about 25 wt % to about 50 wt % sucrose, and from about 0.1 wt % to about 5 wt % hydrolyzed pea protein (for example, Hyfoama PW), and the balance being the beverage constituent. This frozen beverage component can be blended with ice in a blended ice machine or using a blend-in-cup (BIC) machine at the desired concentration to form a frozen beverage according to this disclosure.

### Example 3

A frozen beverage component (syrup) can be prepared which contains from about 40 wt % to about 65 wt % water (diluent), from about 25 wt % to about 50 wt % sucrose, and from about 0.3 wt % to about 3 wt % hydrolyzed pea protein (for example, Hyfoama PW), and the balance being the beverage constituent. This frozen beverage component can be blended with ice in a blended ice machine or using a blend-in-cup (BIC) machine at the desired concentration to form a frozen beverage according to this disclosure.

### Example 4

A frozen beverage component (syrup) can be prepared which contains from about 40 wt % to about 65 wt % water (diluent), from about 25 wt % to about 50 wt % sucrose, and from about 0.5 wt % to about 1 wt % hydrolyzed pea protein (for example, Hyfoama PW), and the balance being the beverage constituent. This frozen beverage component can be blended with ice in a blended ice machine or using a blend-in-cup (BIC) machine at the desired concentration to form a frozen beverage according to this disclosure.

### Example 5

Some examples of the amounts and ranges of hydrolyzed pea protein and other components, both in concentrated form and in the blended finished frozen beverage, are set out in the following tables.

TABLE 1
Exemplary ranges of weight percentages
of finished beverage components

| | | % wt/wt in Finished |
|---|---|---|
| Ingredient | % wt/wt in Syrup | Beverage |
| Pea protein | 0.1-5 | 0.01-3 |
| | 0.3-3 | 0.05-1 |
| | 0.5-1 | 0.1-0.3 |
| Water (including ice) | 45-65 | 80-97 |
| | 50-63 | 82-94 |
| | 55-60 | 85-90 |
| Beverage constituent and | 35-55 | 3-20 |
| additional components | 37-50 | 6-18 |
| | 40-45 | 10-15 |

### Examples 6-11

Several example frozen un-carbonated beverages were prepared in a Taylor™ Blended Ice Machine, by blending a beverage base (orange flavor syrup or lemon-lime flavor syrup), ice, and Hyfoama hydrolyzed pea protein. The theoretical weight of 12 fluid ounces of each liquid beverage was 374 grams. This theoretical weight was calculated based on the known density of the finished beverages of 1.05379 kg/L.

A 12 fl. oz. sample of each frozen beverage was taken from the Blended Ice Machine, allowed to melt, and then weighed. The % expansion of each frozen beverage was then calculated measured by Equation 1, below

$$\frac{{W}_{theoretical} - {W}_{actual}}{{W}_{actual}} * 100 \qquad Equation 1$$

wherein W_{theoretical} is the theoretical weight of 12 fluid ounces of the finished beverage in liquid form (for the beverages tested, 374 grams), and W_{actual} is the actual measured weight of 12 fluid ounces of the melted frozen beverage.

The composition, melted weight, and % expansion of each of Examples 6-12 are shown in the table below.

TABLE 2
Exemplary ranges of weight percentages of finished beverage components

| | | | Weight of | Weight of | | Wt % |
|---|---|---|---|---|---|---|
| | | | 12 fl. oz. of | 12 fl. oz. | | Hyfoama |
| | | | Liquid | of Melted | | in |
| | | Syrup:Ice | Beverage | Beverage | Expansion | Frozen |
| Example | Beverage Constituent | Ratio | (W_{theoretical}) | (W_{actual}) | (%) | Beverage |
| 6 | orange flavor syrup | 45:55 | 374.0 | 279 | 34.05 | 0.1566 |
| 7 | orange flavor syrup | 40:60 | 374.0 | 269 | 39.03 | 0.1506 |
| 8 | orange flavor syrup | 40:60 | 374.0 | 258 | 44.96 | 0.1504 |
| 9 | orange flavor syrup | 45:55 | 374.0 | 279 | 34.05 | 0.1566 |
| 10 | lemon-lime flavor syrup | 45:55 | 374.0 | 274 | 36.50 | 0.1566 |
| 11 | lemon-lime flavor syrup | 45:55 | 374.0 | 289 | 29.41 | 0.1564 |

Surprisingly, as can be seen in the table above, the % expansion of these non-carbonated beverages containing hydrolyzed pea protein was significantly higher than comparable non-carbonated beverages without hydrolyzed pea protein. For example, as would be readily understood by one of skill in the art, typical frozen non-carbonated beverages (which do not contain hydrolyzed pea protein) have an expansion of about 10%, while typical frozen carbonated beverages (which do not contain hydrolyzed pea protein) have from about 80% to about 110% expansion.

Embodiments of the present disclosure provide for compositions and methods for providing frozen beverage compositions and components for use in the same. Accordingly, embodiments of the present disclosure provide for a vast array of options that will allow manufacturers and users alike to enjoy the benefits of the aeration, density, and mouth feel characteristics of carbonated frozen beverages using little or no carbonation.

Throughout this specification, various publications may be referenced. The disclosures of these publications are hereby incorporated by reference in pertinent part, in order to more fully describe the state of the art to which the disclosed subject matter pertains. The references disclosed are also individually and specifically incorporated by reference herein for the material contained in them that is discussed in the sentence in which the reference is relied upon. To the extent that any definition or usage provided by any document incorporated herein by reference conflicts with the definition or usage applied herein, the definition or usage applied herein controls.

Unless indicated otherwise, when a range of any type is disclosed or claimed, for example a range of the sizes, number, percentages, and the like, it is intended to disclose or claim individually each possible number that such a range could reasonably encompass, including any sub-ranges or combinations of sub-ranges encompassed therein. When describing a range of measurements such as sizes or percentages, every possible number that such a range could reasonably encompass can, for example, refer to values within the range with one significant figure more than is present in the end points of a range, or refer to values within the range with the same number of significant figures as the end point with the most significant figures, as the context indicates or permits. For example, when describing a range of percentages such as from 85% to 95%, it is understood that this disclosure is intended to encompass each of 85%, 86%, 87%, 88%, 89%, 90%, 91%, 92%, 93%, 94%, and 95%, as well as any ranges, sub-ranges, and combinations of sub-ranges encompassed therein. Applicants' intent is that these two methods of describing the range are interchangeable. Accordingly, Applicants reserve the right to proviso out or exclude any individual members of any such group, including any sub-ranges or combinations of sub-ranges within the group, if for any reason Applicants choose to claim less than the full measure of the disclosure, for example, to account for a reference that Applicants are unaware of at the time of the filing of the application.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, or ±3% of the stated value.

In any application before the United States Patent and Trademark Office, the Abstract of this application is provided for the purpose of satisfying the requirements of 37 C.F.R. § 1.72 and the purpose stated in 37 C.F.R. § 1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that are employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

Those skilled in the art will readily appreciate that many modifications are possible in the exemplary embodiments disclosed herein without materially departing from the novel teachings and advantages according to this disclosure. Accordingly, all such modifications and equivalents are intended to be included within the scope of this disclosure as defined in the following claims. Therefore, it is to be understood that resort can be had to various other aspects, embodiments, modifications, and equivalents thereof which, after reading the description herein, may suggest themselves to one of ordinary skill in the art without departing from the spirit of the present disclosure or the scope of the appended claims.

Applicants reserve the right to proviso out any selection, feature, range, element, or aspect, for example, to limit the scope of any claim to account for a prior disclosure of which Applicants may be unaware.

1. A frozen beverage composition comprising:
hydrolyzed pea protein;
at least one beverage constituent;
at least one diluent.

2. The frozen beverage composition of claim 1, comprising about 0.01-3 wt % hydrolyzed pea protein.

3.-4. (canceled)

5. The frozen beverage composition of claim 1, wherein the frozen beverage composition is non-carbonated.

6. The frozen beverage composition of claim 1, wherein the frozen beverage composition is carbonated.

7. (canceled)

8. The frozen beverage composition of claim 1, wherein the at least one beverage constituent and the at least one diluent are non-carbonated.

9. The frozen beverage composition of claim 1, wherein at least one of the at least one beverage constituent and the at least one diluent is carbonated.

10.-11. (canceled)

12. A frozen beverage component comprising:
hydrolyzed pea protein;
at least one beverage constituent.

13. The frozen beverage component of claim 12, comprising about 0.1-5 wt % hydrolyzed pea protein.

14.-15. (canceled)

16. The frozen beverage component of claim 12, wherein the frozen beverage component is non-carbonated.

17. The frozen beverage component of claim 12, wherein the frozen beverage component is carbonated.

18.-21. (canceled)

22. A method of making a frozen beverage comprising:
blending at least one beverage constituent, at least one diluent, hydrolyzed pea protein, and ice.

23. The method of claim 22, wherein the at least one beverage constituent, at least one diluent, hydrolyzed pea protein, sweetener, and ice are blended in a blended ice machine.

24. The method of claim 22, wherein the at least one beverage constituent, at least one diluent, hydrolyzed pea protein, sweetener, and ice are blended in a blend in cup machine.

25. The method of claim 22, wherein the frozen beverage is non-carbonated.

26. The method of claim 22, wherein the at least one beverage constituent and the at least one diluent are non-carbonated.

27. A method of making a frozen beverage comprising:
freezing the frozen beverage component of claim 12, and optionally at least one diluent in a frozen beverage dispenser.

28. The method of claim 27, further comprising the step of:
carbonating the frozen beverage component of claim 12.

29. The frozen beverage of claim 5, wherein the frozen beverage has an expansion of from about 30% to about 40%.

30. The method of claim 25, wherein the frozen beverage has an expansion of from about 30% to about 40%.

31. The frozen beverage of claim 6, wherein the frozen beverage has an expansion of from about 80% to about 120%.

32. The method of claim 27, wherein the frozen beverage has an expansion of from about 80% to about 120%.
